(19) United States
(12) Patent Application Publication
(10) Pub. No.: US 2026/0316946 A1
(43) Pub. Date: Oct. 15, 2026

(54) AUTOLAND CONTROL FOR HYBRID ELECTRIC TURBOPROP AIRCRAFT

(71) Applicant: GENERAL ELECTRIC COMPANY, Evendale, OH (US)

(72) Inventors: Brandon W. Miller, Middletown, OH (US); Erich Alois Krammer, West Chester, OH (US); Arthur W. Sibbach, Boxford, MA (US)

(21) Appl. No.: 19/179,310

(22) Filed: Apr. 15, 2025

(51) Int. Cl. B64D 31/06; B64D 31/18; G08G 5/54

(52) U.S. Cl. CPC B64D 31/06; B64D 31/18; G08G 5/54

(57) ABSTRACT

An autoland control system for a hybrid electric aircraft includes a propulsor, a turbomachine, an electric machine, and an autoland controller. The controller autonomously identifies candidate routes to a target destination, calculates a route score for each route based on predicted energy usage by the turbomachine and electric machine, selects a route, and allocates propulsion accordingly without pilot input. The controller can select waypoints based on terrain, weather, or passenger comfort, and can perform fully automated landing, go-around, and post-landing sequences. During landing, the controller monitors runway conditions, adjusts thrust sources, and executes a missed approach if needed. After touchdown, the system manages reverse thrust, idle transitions, and shutdown of the turbomachine based on speed and brake conditions. The system supports improved energy efficiency, reduced noise, and enhanced autonomy for hybrid electric turboprop aircraft.

### TECHNICAL FIELD

The present disclosure relates to providing thrust control. Particularly, the present disclosure relates to autoland control for hybrid electric turboprop aircraft.

### BACKGROUND

A hybrid electric aircraft can include at least one turboprop, turbofan or turboshaft engine having an electric machine. In various hybrid electric aircraft, an autoland feature can be utilized. In the aircraft industry, autoland refers to an automated landing system enabling an aircraft to land with minimal or no input from the pilot. Primarily used in low-visibility conditions, such as fog or heavy rain, autoland allows for a safe, accurate landing even when visibility is severely limited. The system guides the aircraft along a precise approach path, typically using data from the Instrument Landing System (ILS) or other precision aids, to manage the descent, approach, flare, and touchdown, and sometimes even the rollout along the runway. To ensure safety, autoland systems are built with multiple redundancies—often triple-redundant—so that backup systems take over in case of component failure. This technology is especially valuable in commercial and cargo aviation, where it enhances safety and reliability in challenging landing environments or high-traffic areas.

### BRIEF DESCRIPTION OF THE DRAWINGS

Illustrative embodiments can take form in various components and arrangements of components. Illustrative embodiments are shown in the accompanying drawings, throughout which use of like reference numerals can indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an example autoland control for a hybrid electric aircraft system, in accordance with an exemplary embodiment;

FIG. 2 is a schematic diagram of an example implementation of the autoland control for a hybrid electric aircraft system in a single engine aircraft, in accordance with an exemplary embodiment;

FIG. 3 is a schematic diagram of an example implementation of the autoland control for a hybrid electric aircraft system in a multiengine aircraft, in accordance with an exemplary embodiment;

FIG. 4 is a flow diagram of an example method of autoland control for a hybrid electric aircraft system, in accordance with an exemplary embodiment;

FIG. 5 is a flow diagram of an example method of autoland control for a hybrid electric aircraft system up to and including approach, in accordance with an exemplary embodiment;

FIG. 6 is a flow diagram of an example method of autoland control for a hybrid electric aircraft after touchdown, in accordance with an exemplary embodiment; and

FIG. 7 illustrates a device in accordance with an exemplary embodiment.

### DETAILED DESCRIPTION

Prior to discussing the drawings of the present disclosure at length, several terms and concepts are covered in order to facilitate the detailed description of the exemplary embodiments depicted in the drawings. It is noted that however that these terms and concepts do not limit the disclosure and that one of ordinary skill in the relevant art(s) will readily recognize modifications and changes applicable to the following ancillary systems and/or concepts that do not limit the scope of the present teachings.

As mentioned above, a hybrid electric aircraft can include at least one turboprop, turbofan, or turboshaft engine having an electric machine. An autoland can optimize way points for both terrain and energy usage for hybrid electric aircraft having at least one turboprop, turbofan, or turboshaft engine having an electric machine, controlling engine thrust, electric machine output, and propeller angle.

Routes for autoland can be analyzed to limit waste and manage an electrical power source (e.g., battery power, fuel cell, etc.), for example, such that sufficient power remains to be used during landing. In various embodiments, power from the electric machine can be prioritized over the turbomachine during landing, providing, for example, additional power, reducing required braking, and reducing noise pollution.

In various embodiments, energy usage can be optimized between the turbomachine and electric machine for cruise, landing, and any go-arounds.

In various embodiments, a plurality of routes can each include a navigation profile and an altitude profile, for which energy usage is analyzed.

In various embodiments, management of passenger comfort can be affected (e.g., avoiding aircraft noise oscillations and avoiding steep descents). As used herein, ‘noise oscillations’ refer to rapid or perceptible variations in acoustic energy output from the aircraft, such as fluctuations in sound pressure levels caused by transitions between propulsion sources, changes in propeller pitch, or abrupt thrust modulations. Reducing such oscillations can improve passenger comfort and reduce environmental noise footprint.

In various embodiments, minimization of maintenance costs can be affected (e.g., minimizing work on wheels brakes due to high-speed landings, etc.).

In various embodiments, an autoland method can accommodate loss of a propulsor in multi-propulsor aircraft. For example, if the electric machine fails on one propulsion system, electric power can be prioritized on the second propulsion system, to conserve fuel for the turbomachine on the first system. Conversely if the turbomachine on the first system fails, the turbomachine can be prioritized on the second system to conserve electric power for the first propulsion system.

In various embodiments, an autoland method can analyze weather and adapt energy usage between a turbomachine and an electric machine (e.g., manage cold effect on electric machine).

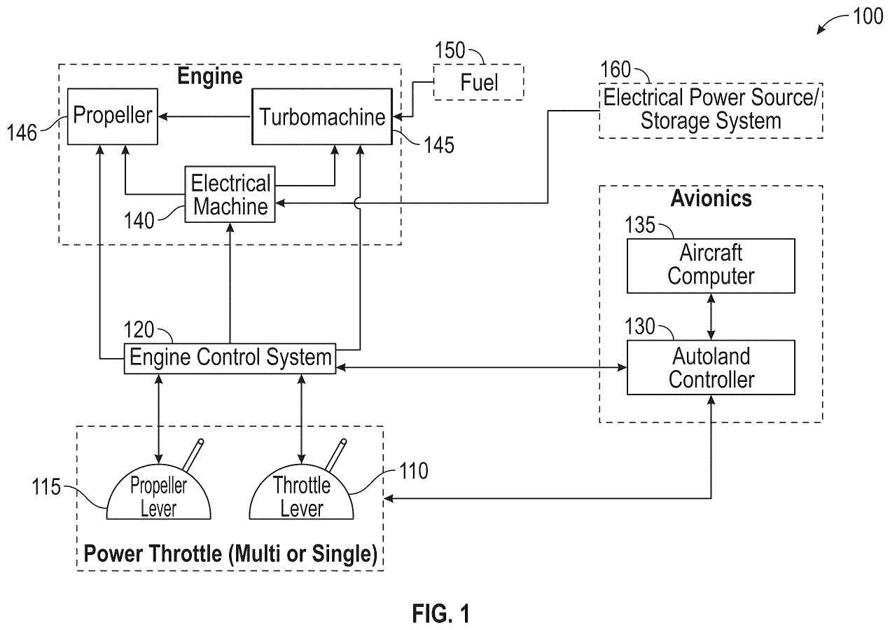

FIG. 1 illustrates an example autoland control for hybrid electric aircraft system 100, in accordance with an exemplary embodiment. The system 100 includes a throttle lever 110 and a propeller lever 115, which in some embodiments can be collectively a power throttle for a multi or single engine aircraft. The throttle lever 110 can control thrust to the engine and the propeller lever 115 can control the pitch of blades 147 on a propeller 146. In various embodiments, a single lever can control both power/speed and pitch of the propeller.

The system 100 also includes an engine control system 120, an autoland controller 130, an aircraft computer 135, an electric machine 140, a turbomachine 145, the propeller 146, a fuel control system 150 and an electrical power source/storage system 160.

In various embodiments, the autoland controller 130 and the aircraft computer 135 can be part of an avionics system of the aircraft, and the electric machine 140, the turbomachine 145 and the propeller 146 can be part of an engine system of the aircraft.

In various embodiments, the throttle lever 110 and the propeller lever 115 are in communication with the engine control system 120 and the autoland controller 130. The autoland controller 130 is in communication with the engine control system 120 and the aircraft computer 135.

In various embodiments, the engine control system 120 is in communication with the electric machine 140, the turbomachine 145 and the propeller 146. The electric machine 140 is also in communication with the turbomachine 145 and the propeller 146.

In various embodiments, the fuel control system 150 provides fuel to the turbomachine 145 and the electrical power source/storage system 160 provides electrical power/energy to the electric machine 140. As mentioned above, the electrical power source/storage system 160 can be in the form of batteries, APU, Fuel Cell, etc.

As shown in FIG. 1, the autoland controller 130 provides control to the engine control system 120 by receiving input from the power throttle (e.g., throttle lever 110 and propeller lever 115), in addition to data received from the aircraft computer 135, which in various embodiments, can include information to aid the autoland controller 130 to select a thrust mode such as fuel, electrical or a hybrid fuel/electric thrust.

In various embodiments, therefore, the engine control system 120 controls the electric machine 140 and the turbomachine 145 to provide power to the propeller 146 (e.g., to rotate the shaft of the propeller 146 and/or to adjust the pitch of blades 147 of the propeller 146.

The fuel control system 150 provides fuel to the turbomachine 145, while the electrical power source/storage system 160 provides electrical power/energy to the electric machine (e.g., motor/engine) to power the propeller 146.

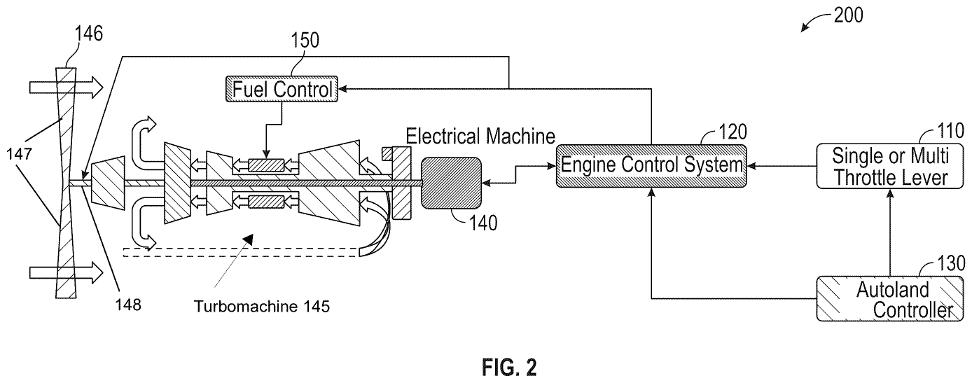

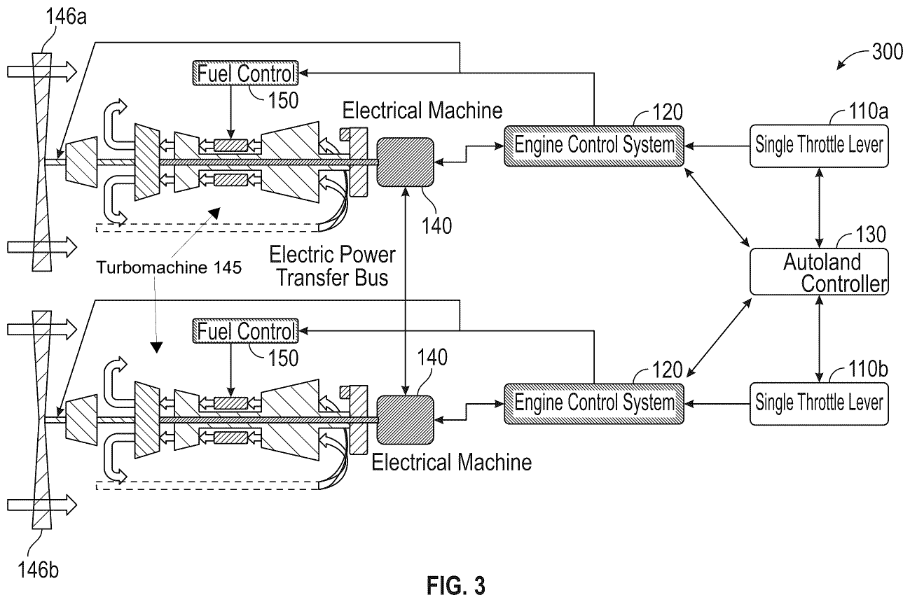

FIG. 2 is a schematic diagram of an example implementation of the autoland controller 130 for hybrid electric aircraft system 200 in a single engine aircraft, in accordance with an exemplary embodiment. In various embodiments, the components shown in FIG. 2 can correspond to the components described above in FIG. 1. The system 200 includes a turbomachine 145 and an electric machine 140 operatively coupled to a common shaft for driving a propeller 146 (such as propellers 146a and 146b seen in FIG. 3), which enables coordinated or independent thrust generation from either the turbomachine 145 or the electric machine 140. The turbomachine 145 receives fuel from a fuel control system 150, while the electric machine 140 receives electrical energy from an electrical power source or storage system 160 (e.g., a battery, APU, or fuel cell). The throttle lever 110 provides pilot or autopilot input to the engine control system 120 and the autoland controller 130. In various embodiments, the autoland controller 130 receives additional data from the aircraft computer 135, such as navigation data, environmental inputs (e.g., wind or terrain), aircraft configuration, and system health status. Based on these inputs, the autoland controller 130 selects an energy-optimal thrust mode—fuel-based, electric-based, or hybrid—and sends control signals to the engine control system 120. The engine control system 120, in turn, manages actuation of the turbomachine 145 and electric machine 140 to produce a targeted propulsive output and, where applicable, modulates the propeller pitch angle to improve aerodynamic performance.

In the embodiment shown in FIG. 2, the electric machine 140 is mechanically coupled to a propeller shaft 148 and may operate in either a motoring mode (e.g., driving the shaft 148 to produce thrust) or a regenerative mode (e.g., extracting energy from the shaft 148-when the shaft 148 is rotating-to recharge a battery or electrical storage system not explicitly shown), depending on the phase of flight and the logic implemented by the autoland controller 130. During descent and landing, the autoland controller 130 can prioritize use of the electric machine 140 to reduce acoustic signature (e.g., lower noise emissions from propeller and engine operation), decrease braking load (e.g., reduce wear on wheel brakes by using reverse thrust or regenerative drag), or conserve fuel (e.g., minimize turbomachine operation). The autoland controller 130 is configured to operate autonomously, including selection of targeted descent profiles (e.g., vertical flight path from cruise altitude to landing), adherence to glide slopes (e.g., a defined angular path for approach, such as that provided by an Instrument Landing System), initiation of flare (e.g., raising the aircraft nose just before touchdown to reduce descent rate), and touchdown sequencing (e.g., timing and control adjustments made during the transition from descent to ground roll), all without requiring pilot intervention. The system architecture also supports energy-aware go-around logic, wherein the autoland controller 130 dynamically allocates propulsion source usage (e.g., toggling between or combining electrical and fuel-based thrust) based on real-time power availability (e.g., battery state-of-charge, fuel reserves) and mission constraints (e.g., terrain avoidance, airspace separation, or runway conditions). In various embodiments, the autoland controller 130 coordinates thrust control with flight control systems (e.g., control surfaces such as ailerons, elevators, and rudder) to maintain a stable and precise trajectory along either predefined or dynamically computed landing paths. FIG. 3 is a schematic diagram of an example implementation of the autoland controller 130 for hybrid electric aircraft system 300 in a multiengine aircraft, in accordance with an exemplary embodiment. In various embodiments, the components shown in FIG. 3 can correspond to the components described above in FIG. 1.

In the embodiment shown in FIG. 3, a first electric machine 140 is shown as being connected to the shaft driving the propeller 146A, while a second electric machine 140 is shown as being connected to the shaft driving the propeller 146B. Similarly, a first fuel control system 150 is shown providing fuel to a first engine that provides power to propeller 146A, while a second fuel control system 150 is shown providing fuel to a second engine that provides power to propeller 146B.

In various embodiments, a single throttle lever 110a provides input from a pilot that is communicated to the engine control system 120 and the autoland controller 130 to provide thrust by fuel, electric or a hybrid fuel/electric energy for propeller 146A, while a second single throttle lever 110b provides input from a pilot that is communicated to the engine control system 120 and the autoland controller 130 to provide thrust by fuel, electric or a hybrid fuel/electric energy for propeller 146B.

In various embodiments, either single throttle lever 110a or 110b can be utilized to provide control for both propellers 146A and 146B.

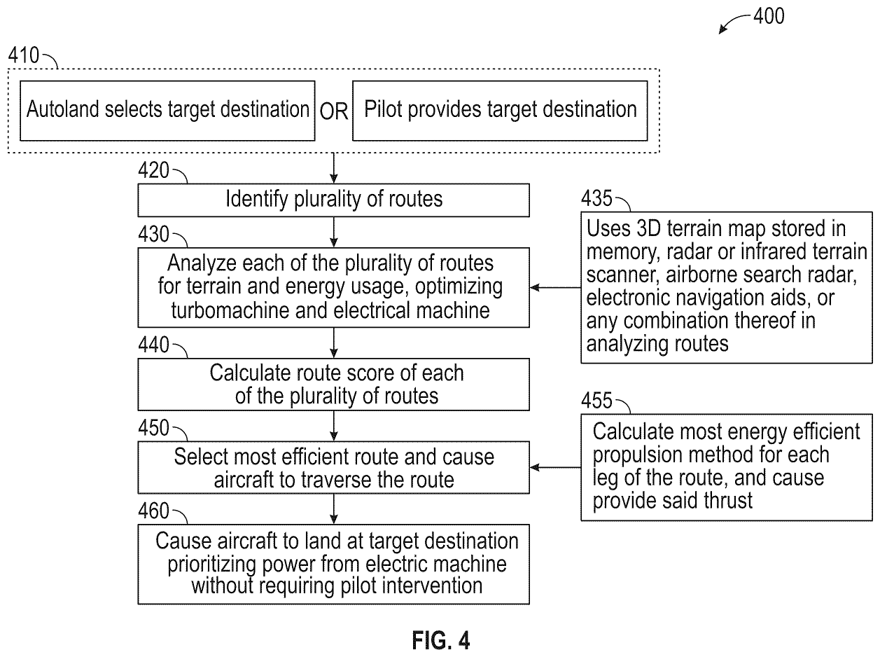

FIG. 4 is a flow diagram of an example method 400 of autoland control for hybrid electric aircraft system, in accordance with an exemplary embodiment.

At block 410, the autoland controller 130 selects a target destination or the target destination is provided by the pilot. In various embodiments, the target destination can be selected based on factors described above (e.g., routes that limit waste, energy usage, or fuel consumption). For example, if the aircraft experiences a partial propulsion system fault or is operating under constrained battery reserves, the autoland controller 130 may evaluate multiple viable landing sites within range and select the destination that enables the most energy-efficient descent profile. This could include, for instance, choosing an airport with a lower elevation relative to the aircraft's current position to minimize required engine thrust during descent, or selecting a runway that enables a direct approach aligned with prevailing winds to reduce maneuvering and throttle changes. In some embodiments, the controller 130 may also prioritize destinations equipped with ground charging infrastructure or maintenance facilities, particularly when electrical power reserves are low or a hybrid system fault is detected. These factors can be evaluated individually or in combination as part of the route score determination process described further below.).

At block 420, a plurality of routes is identified. In various embodiments, once a target destination is selected, the autoland controller 130 accesses onboard or external navigation databases (e.g., flight management system (FMS) data, terrain databases, and airway structures) to generate or retrieve multiple candidate routes to the selected destination. These routes may include standard approach procedures (e.g., STARs or published instrument approaches), dynamically computed descent paths, or alternate emergency approaches based on current aircraft state, weather, and terrain. In some embodiments, the controller 130 uses a real-time path-planning algorithm that considers flight constraints such as no-fly zones, terrain clearance, glide slope availability, wind conditions, and aircraft configuration (e.g., weight, remaining battery/fuel, engine status). Each of the plurality of routes can include a navigation profile (e.g., lateral waypoints, headings, turn points) and/or an altitude profile (e.g., top-of-descent point, intermediate descent steps, and minimum safe altitudes), as described above. At block 430, each of the plurality of routes is analyzed for terrain and energy usage, optimizing between the turbomachine and electric machine as described above. In various embodiments, at block 435, a three-dimensional (3D) terrain map stored in memory, radar or infrared terrain scanner, airborne search radar, electronic navigation aids or a combination thereof can be used in order to analyze the routes at block 430.

At block 440, a route score is calculated for each of the plurality of routes. In various embodiments, the route score is a composite evaluation based on multiple factors, each of which may be assigned a relative weight or priority depending on aircraft configuration and mission context. In some embodiments, the autoland controller employs a machine learning model to estimate predicted energy usage and passenger comfort levels for candidate routes. The model may be trained on historical flight data, environmental conditions, aircraft performance logs, or simulated trajectories to improve scoring accuracy and route selection in varying operational contexts. Factors contributing to the route score can include predicted energy consumption (e.g., estimated battery and/or fuel usage along the route), time required to reach the destination, terrain clearance and avoidance, weather conditions, and proximity to no-fly or restricted zones. The route score may also incorporate criteria related to passenger comfort, which can be inferred from predicted flight characteristics. For example, the autoland controller 130 can estimate comfort using metrics such as descent rate, the number and severity of turns along the route, anticipated vertical acceleration (e.g., due to turbulence or steep glide angles), or expected in flight noise levels based on propulsion source and power setting. In some embodiments, the controller uses these values to penalize routes that would cause excessive maneuvering, steep descents, or louder engine operation, thereby promoting smoother and quieter approaches. The controller 130 can access stored models, safety margins, or threshold values to quantify comfort-related effects and incorporate them into the overall route score. In some embodiments, the autoland controller 130 considers a descent to be “steep” if the descent angle exceeds a predefined threshold (e.g., greater than 3 degrees relative to horizontal) or if the rate of descent exceeds a vertical speed threshold (e.g., greater than 1,000 feet per minute during final approach). These values may be configurable based on aircraft type, weight, or mission profile.

Accordingly, at block 450, the autoland controller 130 selects the most efficient route to the target destination based on the previously calculated route scores. In this context, efficiency can be defined according to mission priorities, such as minimizing energy consumption, avoiding complex terrain or weather, preserving battery life, or maintaining system redundancy. Once a route is selected, the autoland controller generates and issues a sequence of control commands to the engine control system and other avionics components to initiate traversal of the selected route. This can include adjusting throttle settings, propeller pitch, aircraft attitude, and flight control surface deflections to align with the planned navigation and altitude profiles. In various embodiments, the controller 130 continuously monitors real-time aircraft state data (e.g., position, airspeed, heading, altitude) and updates the control commands to ensure the aircraft remains on the selected path. If deviations occur—such as from wind shear, navigation drift, or unexpected aircraft behavior—the controller 130 can adjust the flight trajectory dynamically to maintain conformance with the route, or re-evaluate route options if needed.

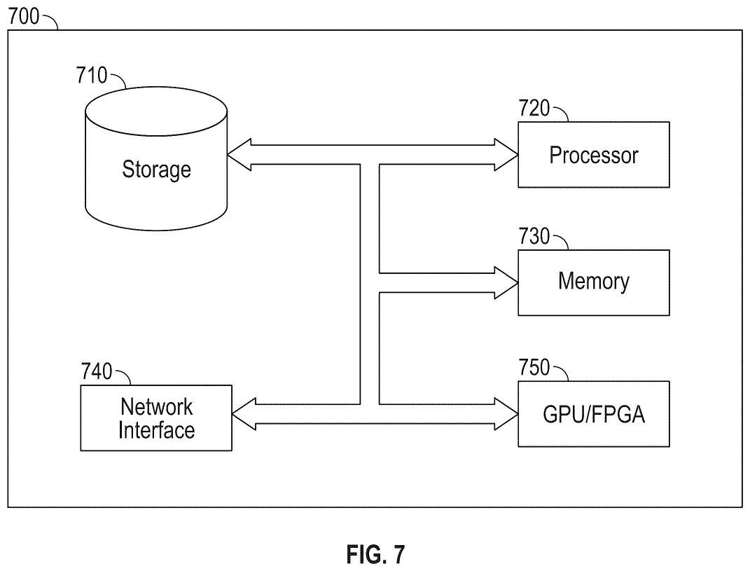

In various embodiments, the autoland controller 130 can incorporate or be operatively coupled to one or more machine learning models to improve or optimize route scoring and selection. For example, historical flight data, sensor data, environmental conditions, and energy usage profiles may be used to train a model (e.g., a neural network, decision tree, or regression ensemble) that predicts a preferred route score for a given set of conditions. These models can be executed by a GPU or FPGA (e.g., device 700 of FIG. 7), allowing the system to dynamically adjust or weight factors such as comfort, terrain avoidance, or propulsion efficiency in response to mission-specific goals or learned behavior over time. In some embodiments, the autoland controller 130 uses these models to refine or override manually defined scoring logic, enhancing decision-making under complex or uncertain conditions.

At block 455, in various embodiments, the most efficient route can also include a segmented analysis of propulsion requirements for each leg of the route—such as cruise descent, intermediate approach, final approach, and flare. For each segment, the autoland controller 130 calculates the most energy-efficient propulsion method by comparing predicted fuel burn and electrical power consumption under various configurations (e.g., electrical-only, turbomachine-only, or hybrid operation). The controller 130 can consider factors such as required thrust level, airspeed, engine thermal efficiency, electrical state-of-charge, and system health status to make this determination. Based on this analysis, the controller selects and configures the propulsion system that delivers the optimal combination of thrust and efficiency for that segment. For instance, the controller can use electrical propulsion for a low-power, noise-sensitive final approach leg, while retaining turbomachine thrust for segments requiring greater climb capability or sustained output. Transitions between propulsion modes can be seamlessly coordinated by the engine control system under command of the autoland controller 130. At block 460, the autoland controller causes the aircraft to land at the target destination, executing the final phase of the selected route without requiring pilot intervention. During this phase, the controller 130 can prioritize power from the electrical machine 140 over the turbomachine 145 for benefits such as noise reduction, lower emissions, or reduced braking demand. For example, the electrical machine 140 can provide fine-grained thrust control during flare and touchdown, helping achieve smoother landings and reduced runway overrun risk. The autoland controller 130 also manages associated systems such as flap settings, landing gear deployment, and engine idle transitions to maintain optimal aircraft configuration throughout the landing. In various embodiments, the system continuously monitors altitude, descent rate, and ground proximity using radar altimeters, inertial sensors, and navigation systems to control the final descent profile with high precision. Upon touchdown, the system transitions to rollout and post-landing procedures.

Although various blocks of the method 400 are shown in an order, it should be noted that not all blocks can be implemented and any order can be implemented to the blocks of method 400.

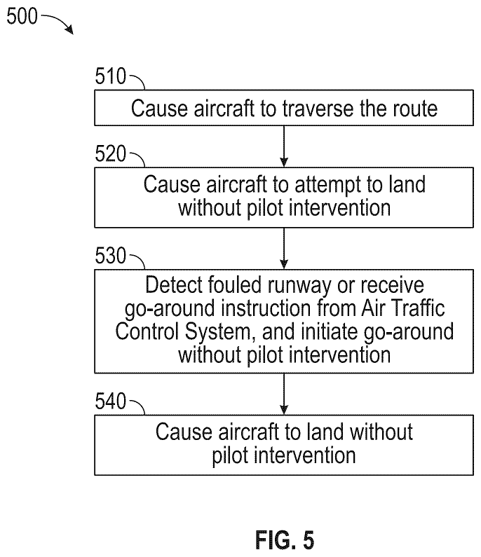

FIG. 5 is a flow diagram of an example method 500 of autoland control for hybrid electric aircraft system up to and including approach, in accordance with an exemplary embodiment. In various embodiments, method 500 represents a more detailed implementation of a portion of the higher-level method 400 described in FIG. 4—specifically expanding upon operations performed during route traversal and approach, such as those illustrated in blocks 450 through 460. While method 400 provides a generalized overview of route selection and autoland sequencing, method 500 elaborates on intermediate steps during the descent and approach phases, including configuration changes (e.g., flap settings and landing gear deployment), airspeed management, and automated course corrections during final approach. In this regard, method 500 serves as an illustrative embodiment of the execution logic within the autoland controller 130 during the final legs of the selected route prior to landing. In some embodiments, steps from method 500 may be integrated directly into or executed concurrently with blocks 450 through 460 of method 400.

At block 510, the autoland controller 130 causes the aircraft to traverse the route for landing. In various embodiments, this involves commanding the aircraft to follow a predetermined or dynamically generated sequence of navigation waypoints and altitude targets, including approach legs such as initial, intermediate, final, and missed approach segments. These legs may align with published instrument approach procedures (e.g., ILS or RNAV approaches) or be constructed in real time based on aircraft state, terrain, and weather data. As the aircraft progresses along the route, the autoland controller 130 continuously monitors position, speed, altitude, and heading, making real-time adjustments to throttle, pitch, and flight control surfaces to ensure conformance with the expected flight path. The controller 130 can also manage transitions between flight phases, such as initiating descent from cruise altitude or leveling off at intermediate altitudes. Additionally, the route can include navigational markers or fixes (e.g., final approach fix (FAF), decision altitude (DA), or minimum descent altitude (MDA)) that define key decision points or configuration changes during approach. In some embodiments, the autoland controller 130 uses this information to coordinate aircraft configuration changes such as extending landing gear, adjusting flap settings, and preparing for flare and touchdown.

At block 520, the autoland controller 130 causes the aircraft to attempt to land on the runway without pilot intervention. In various embodiments, this executing the final approach by keeping the aircraft aligned both vertically and horizontally with the planned landing path. The autoland controller 130 adjusts the aircraft's airspeed, descent rate, and heading to stay on a defined descent profile—such as a glideslope provided by an Instrument Landing System (ILS) or a GPS-based glidepath—and to remain centered along the runway's extended centerline. This may include using signals from a localizer (a guidance component that emits a radio signal aligned with the centerline of the runway to stay laterally aligned with the runway during approach) or GPS data to ensure the aircraft does not drift left or right during approach. The controller 130 commands real-time control surface adjustments (e.g., elevators, ailerons, rudder), throttle or electrical output changes, and propeller pitch modifications to maintain this alignment. Concurrently, the controller 130 configures the aircraft for landing by deploying flaps to increase lift at lower speeds, applying trim adjustments to stabilize pitch, and lowering the landing gear at the appropriate point. These actions are informed by live aircraft state data such as airspeed, altitude, and descent rate, as well as current environmental conditions. In some embodiments, the controller 130 can further adjust its descent and configuration in response to runway surface conditions or atmospheric turbulence to ensure a safe and stable touchdown. At block 530, in various embodiments, the autoland controller can detect a fouled runway (e.g., an obstruction, debris, or other aircraft on the landing path) and/or receive go-around instructions from an air traffic controller (ATC) or ATC system. A go-around refers to an aborted landing maneuver in which the aircraft discontinues its descent and initiates a climb to either reattempt the approach or divert to an alternate airport. This procedure may be triggered manually by the pilot or automatically by the autoland controller based on sensor data or received instructions. In response, the autoland controller can initiate a go-around sequence without pilot intervention, including reconfiguring aircraft flaps and gear, adjusting pitch attitude, and commanding increased thrust to achieve climb-out. In various embodiments, the autoland controller 130 can adjust the turbomachine to an idle mode to maintain the go-around airspeed, and/or make adjustments to both the turbomachine and electric machine to maintain capability for acceleration for climb out, etc., during the go-around. In various embodiments, the controller 130 can modulate the turbomachine 145 and/or electrical machine 140 outputs to maintain airspeed and altitude appropriate for the missed approach procedure or alternate routing. Detection of a fouled runway can be facilitated by onboard systems such as an air to ground radar, forward looking infrared (FLIR) detection system, or through electronic communication from external traffic control sources such as a control tower or other air traffic control indication system.

In various embodiments, at block 530, the autoland controller can initiate missed approach procedures upon the aircraft reaching a missed approach point (MAP) during final approach. The missed approach point is a predefined location-typically associated with an altitude or distance threshold—beyond which the aircraft must not continue descending unless sufficient visual or sensor-based confirmation of a safe landing environment has been made (e.g., the runway is in sight and clear). If, at the MAP, the autoland controller 130 determines that landing conditions are not satisfactory—due to factors such as a fouled runway, unstable approach, degraded sensor input, or failure to acquire required landing guidance—the system will automatically transition to a missed approach maneuver. This includes commanding an increase in thrust (e.g., turbomachine and/or electrical machine output), adjusting aircraft pitch and climb angle, and reconfiguring the aircraft (e.g., retracting landing gear, adjusting flaps) to initiate a safe climb-out. The autoland controller 130 can then direct the aircraft to fly a predefined missed approach route, which can be based on published procedures, dynamic terrain avoidance paths, or alternate approach paths. Once safely established on the missed approach path, the controller 130 can evaluate whether to reattempt landing at the original destination, divert to an alternate airfield, or remain in a holding pattern while awaiting new instructions or improved conditions.

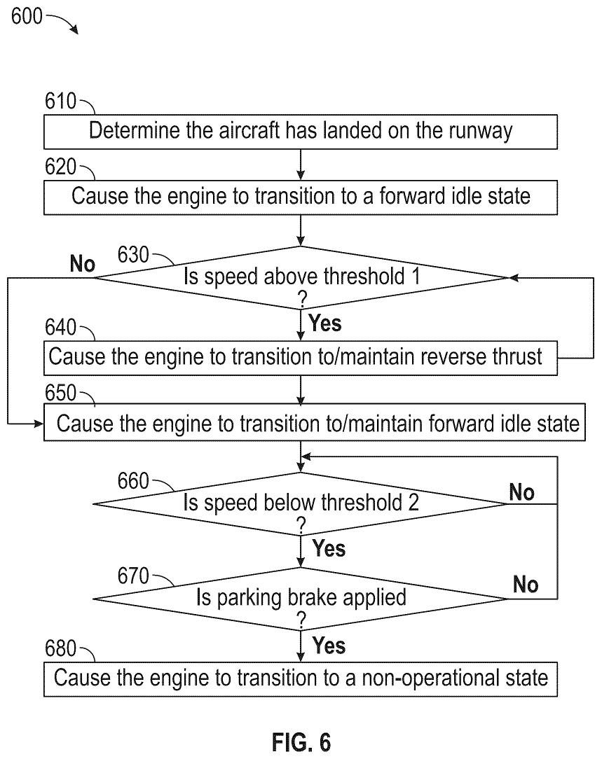

Accordingly, at block 540, the autoland controller 130 causes the aircraft to land without pilot intervention. In various embodiments, this includes executing the final descent segment by managing pitch, roll, and thrust to precisely follow the vertical and lateral approach profiles down to the runway threshold. As the aircraft nears the runway surface, the controller 130 initiates the flare maneuver, where the aircraft's nose is gently raised to reduce descent rate and achieve a smooth touchdown. This maneuver is executed based on real-time altitude, descent rate, and airspeed measurements, often using radar or laser altimeters to detect ground proximity. The controller 130 modulates thrust from the turbomachine 145 and/or electrical machine 140 during this phase to maintain the target landing speed and to avoid over-or under-shooting the touchdown zone. Upon runway contact, the controller 130 may also coordinate additional landing behaviors such as holding elevator position to maintain aerodynamic braking or managing pitch-down for nosewheel touchdown, if applicable. In some embodiments, touchdown detection may trigger an automatic transition into rollout control, as described further in method 600. FIG. 6 is a flow diagram of an example method 600 of autoland control for hybrid electric aircraft after touchdown, in accordance with an exemplary embodiment. In various embodiments, method 600 continues from the final phase of method 500 (FIG. 5), expanding specifically on the actions taken by the autoland controller 130 once the aircraft has physically contacted the runway. Whereas FIG. 4 provides a high-level overview of route selection and automated landing, and FIG. 5 details approach and descent operations, FIG. 6 focuses on the autonomous rollout and shutdown sequence that follows touchdown. The steps in method 600 illustrate how the autoland controller 130 manages aircraft deceleration, transitions between thrust states (e.g., forward idle to reverse thrust), monitors rollout speed, and determines when to shut down the propulsion system after the aircraft has safely come to a stop. This includes decision points based on measured ground speed thresholds and system status indicators, and may also involve integration with aircraft braking systems, taxiing logic, and parking brake sensors. Method 600 therefore represents the final phase of the fully automated landing cycle and ensures safe completion of the landing process without pilot input.

At block 610, the autoland controller determines that the aircraft has landed—that is, it has made physical contact with the runway surface and has fully transitioned from flight to ground roll. This determination may be made based on a combination of sensor inputs, including signals from weight-on-wheels (WoW) sensors that detect compression of the landing gear, radar or laser altimeters indicating zero altitude above ground, and a rapid change in vertical acceleration captured by onboard inertial measurement units (IMUs). In some embodiments, the controller 130 can also correlate airspeed decay, sudden reduction in descent rate, or a shift in aerodynamic control authority to confirm touchdown. Once touchdown is verified, at block 620, the autoland controller 130 transitions the propulsion system into a forward idle state to allow the aircraft to decelerate along the runway. This throttle adjustment reduces propulsive force while maintaining sufficient engine or motor output to power essential systems such as hydraulics, avionics, or braking support. The ‘idle state’ of the turbomachine, as used herein, refers to a low-thrust operational condition in which fuel flow is maintained at a minimal level sufficient to keep the engine running, but without producing significant forward propulsion. In hybrid embodiments, the controller 130 can choose to idle the turbomachine 145 while allowing the electrical machine 140 to provide residual power for taxi or braking support. This forward idle state provides a safe baseline configuration for controlled rollout, reducing speed in preparation for either reverse thrust engagement or taxi phase handover.

At block 630, the autoland controller 130 determines if the rollout speed is above a first threshold (e.g., threshold 1) which represents the speed above which active deceleration—such as reverse thrust—may be required to ensure safe stopping within the available runway length. To make this determination, the autoland controller 130 monitors ground speed data from onboard systems such as the air data computer (ADC), GPS receivers, or wheel speed sensors. In some embodiments, the controller 130 cross-checks these sources for consistency to validate the measured speed. The threshold itself may be fixed (e.g., based on aircraft type and runway length) or dynamically calculated based on real-time conditions such as runway surface friction (e.g., wet vs. dry), wind direction and speed, aircraft weight, or the length of remaining runway. If the measured rollout speed exceeds this threshold, the controller 130 determines that additional deceleration is needed to reduce the risk of runway overrun or excessive brake wear, and proceeds to engage reverse thrust logic, as described in the following block.

If the rollout speed is above threshold 1 at block 630, then the autoland controller 130 causes the engine to transition to reverse thrust (or maintain reverse thrust if already in reverse thrust) as indicated at block 640. In various embodiments, the autoland controller 130 deploys thrust reversers to initiate/maintain reverse thrust (e.g., altering the pitch of the propellors), which provides additional aerodynamic braking to decelerate the aircraft more rapidly than brakes alone, particularly during high-speed rollout or on slippery runway surfaces.

The method then reverts to block 630 to monitor whether or not the rollout speed is above threshold 1. If the rollout speed is not above threshold 1, then the autoland controller 130 causes the engine to transition to the forward idle state if in reverse thrust state as indicated at block 650, or maintain the forward idle state if not in the reverse thrust state. This loop ensures the controller 130 maintains continuous evaluation of speed conditions and adjusts engine state in real-time to match the required deceleration strategy.

At block 660, the autoland controller 130 determines if the aircraft speed is below a second threshold (e.g., threshold 2), which corresponds to a low-speed condition typically associated with taxiing or near-stop scenarios. If the speed is above threshold 2, then the autoland controller 130 maintains the forward idle state and continues to monitor the rollout speed with respect to threshold 2.

If, at block 660, the rollout speed is below threshold 2, then, at block 670, the autoland controller 130 determines whether or not the parking brake is applied, which is interpreted as an indication that the aircraft has reached its final stop (e.g., arrived at the gate or designated parking area). If the parking brake is not applied, then the method continues to monitor the speed in comparison to threshold 2 at block 660, and whether the parking brake has been applied at block 670. In various embodiments, this can allow the autoland controller 130 to determine whether or not the aircraft has been taxied to a parking area.

In some embodiments, the controller 130 can use machine-learned models trained on landing and rollout behavior to refine or validate threshold decisions or braking control logic.

If, at block 670, the parking brake is applied (e.g., the aircraft has been parked), then the autoland controller 130 can cause the engine to transition to a non-operational state at block 680. The term ‘non-operational state’ refers to a complete shutdown of the turbomachine, including cessation of fuel delivery, rotor spin-down, and disabling of associated mechanical subsystems (e.g., compressors, turbines), while optionally allowing electrical systems to remain powered by an auxiliary power unit (APU) or battery backup. In various embodiments, this can include turning the turbomachine 145 off, disabling fuel flow, and/or powering down associated subsystems, while allowing electrical systems to remain active via the electrical power source or auxiliary power unit (APU), if necessary.

Accordingly, method 600, in various embodiments provides for the autoland controller 130 to autonomously manage post-touchdown propulsion states: transitioning from forward to reverse thrust to aid in deceleration, reverting to forward idle once safe rollout speed is achieved to maintain necessary onboard power, and finally shutting down the engine once the aircraft has stopped and is secured with the parking brake applied. This sequence enables fully automated rollout and post-landing control without pilot input.

Although various blocks of methods 500 are 600 are shown in an order, it should be noted that not all blocks are implemented and any order can be implemented to the blocks of methods 500 and/or 600.

FIG. 7 is a block diagram of a device 700 of the system of FIG. 1, in accordance with one embodiment. In various embodiments, device 700 can be implemented in the engine control system 120 and/or the autoland controller 130 of FIG. 1. Referring now to FIG. 7, exemplary components in the device 700 in accordance with aspects of the present disclosure include, for example, a database 710, one or more processors 720, at least one memory 730, and a network interface 740. In aspects, the device 700 can include a graphical processing unit (GPU) 750, which can be used for processing machine learning network models. Various components of device 700 can be utilized to carry out instructions to perform the operations described in blocks 410-460 of FIG. 4, blocks 510-540 of FIG. 5, and/or blocks 610-680 of FIG. 6.

Database 710 can be located in storage. The term “storage” can refer to any device or material from which information can be capable of being accessed, reproduced, and/or held in an electromagnetic or optical form for access by a computer processor. Storage can be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In various aspects, data can be stored on device 700, including, for example, user preferences, historical data, and/or other data. The data can be stored in database 710 and sent via the system bus to processor 720.

As described above, processor 720 can execute various processes based on instructions that can be stored in the server memory 730 and utilizing the data from database 710. The illustration of FIG. 7 is exemplary, and persons skilled in the art will be understood by other components that can exist in the device 700. Such other components are not illustrated in FIG. 7 for clarity of illustration.

Accordingly, described above in various embodiments is an autoland method that optimizes way points for both terrain and energy usage for hybrid electric aircraft having at least one turboprop or turboshaft engine having an electric machine, controlling engine thrust, electric machine output, and propeller angle.

In various embodiments, routes are analyzed to limit waste and manage battery power, (e.g., such that sufficient power remains to be used during landing). Power from an electric machine can be prioritized over a turbomachine during landing, providing additional power, reducing required braking, and reducing noise pollution.

In various embodiments, energy usage is optimized between the turbomachine and electric machine for cruise, landing, and any go-arounds.

The technical challenge addressed by the present disclosure lies in the need to dynamically and efficiently manage multiple propulsion sources—specifically a turbomachine and an electric machine—across varying flight phases, while ensuring the reliability, safety, and autonomy required for an automated landing. Traditional autoland systems are typically optimized for single-mode propulsion architectures and do not account for the energy trade-offs or mission constraints unique to hybrid-electric configurations. The disclosed system provides a technological solution by integrating real-time route evaluation, adaptive propulsion control, and automated descent and landing logic that optimizes energy usage across both propulsion sources. This enables the aircraft to conserve critical resources (e.g., battery power or fuel), reduce noise and emissions during sensitive phases like landing, and maintain thrust continuity even in the event of partial propulsion system failure. The result is a more efficient, resilient, and environmentally responsive autoland capability tailored to the operational characteristics of hybrid electric aircraft.

Further aspects of the present disclosure are provided by the subject matter of the following clauses.

An example autoland control system of an aircraft comprises a propulsor including one or more blades, a turbomachine, an electric machine, and an autoland controller operatively coupled with the propulsor, the turbomachine, and the electric machine. The autoland controller is configured to autonomously: identify one or more candidate routes for transit to a target destination; calculate a route score for each candidate route based at least in part on predicted energy usage by the turbomachine and the electric machine along the respective route; select a route for transit from the one or more candidate routes based upon the calculated route score; and based on the selected route, selectively control the turbomachine and/or the electric machine to provide power changes to the propulsor during transit along the selected route without requiring pilot intervention.

The autoland control system according to the preceding clause, wherein the autoland controller is configured to select one or more waypoints on the selected route based at least in part on characteristics of terrain along the route.

The autoland control system according to any preceding clause, wherein the calculating the route score includes analyzing each route based on at least one of reducing waste energy, minimizing fuel consumption, or conserving electrical power.

The autoland control system according to any preceding clause, wherein each of the one or more routes includes one or more of a navigation profile or an altitude profile.

The autoland control system according to any preceding clause, wherein the autoland controller is configured to analyze an energy usage for the navigation profile or the altitude profile.

The autoland control system according to any preceding clause, wherein the autoland controller is configured to select a route based at least in part on estimated passenger comfort, the estimated passenger comfort being based on predicted flight profile parameters including one or more of descent rate, number of turns, or expected in-flight noise levels.

The autoland control system according to any preceding clause, wherein the autoland controller is configured to minimize aircraft noise oscillations and to suppress descent rates that exceed passenger comfort thresholds.

The autoland control system according to any preceding clause, wherein the autoland controller is configured to analyze weather conditions to select the route.

The autoland control system according to any preceding clause, wherein the autoland controller is configured to autonomously identify the target destination or receive the target destination from a pilot, and wherein the autoland controller is further configured to perform route selection and propulsion control without requiring pilot input.

The autoland control system according to any preceding clause, wherein the autoland controller is configured to prioritize power to the turbomachine based upon a failure of the electric machine or conserve electrical power for the electric machine based upon a failure of the turbomachine.

An autoland control system for an aircraft comprises a propulsor including one or more blades, a turbomachine, an electric machine, and an autoland controller operatively coupled with the propulsor, the turbomachine, and the electric machine. The autoland controller is configured to autonomously: selectively control the turbomachine and/or the electric machine to provide power changes to the propulsor during a landing sequence on a runway; detect a condition to abort or continue the landing sequence; upon detection of a condition to abort landing on the runway, control the turbomachine and/or the electric machine to provide power to the propulsor to execute a go-around or missed approach; and upon detection of a condition to continue landing on the runway, control the turbomachine and/or the electric machine to provide power to the propulsor to complete landing on the runway without requiring pilot intervention.

The autoland control system according to the preceding clause, wherein the autoland controller is configured to detect a fouled runway.

The autoland control system according to any of the preceding clauses, wherein the autoland control system receives information about the fouled runway from one or more of an air to ground radar, forward looking infrared (FLIR) detection system, electronic communication from a control tower, or other air traffic control indication system.

The autoland control system according to any of the preceding clauses, wherein the autoland controller is configured to initiate go-around or missed approach procedures.

The autoland control system according to any of the preceding clauses, wherein the autoland controller is configured to idle the turbomachine.

The autoland control system according to any of the preceding clauses, wherein the autoland controller deploys landing gear.

An autoland control system for an aircraft comprises a propulsor including one or more blades, a turbomachine, an electric machine, and an autoland controller operatively coupled with the propulsor, the turbomachine, and the electric machine. The autoland controller is configured to autonomously: determine that an aircraft has landed on a runway; control the turbomachine to transition to a forward idle state following landing; determine, based upon an aircraft speed exceeding a first threshold, to initiate reverse thrust using the turbomachine; and cause the turbomachine to transition to a non-operational state based upon the aircraft speed being below a second threshold and a parking brake being applied.

The autoland control system according to the preceding clause, wherein the autoland controller is configured to, based upon the aircraft speed being below the first threshold, discontinue thrust reversing.

The autoland control system according to any of the preceding clauses, wherein the autoland controller is configured to maintain the idle state of the turbomachine.

The autoland control system according to any of the preceding clauses, wherein the autoland controller is configured to turn the turbomachine off.

Those skilled in the relevant art(s) will appreciate that various adaptations and modifications of the embodiments described above can be configured without departing from the scope and spirit of the disclosure. Therefore, it is to be understood that, within the scope of the appended claims, the teachings featured herein can be practiced other than as specifically described herein.

1. An autoland control system of an aircraft, comprising:
a propulsor including one or more blades;
a turbomachine;
an electric machine; and
an autoland controller operatively coupled with the propulsor, the turbomachine, and the electric machine, the autoland controller configured to autonomously:
identify one or more candidate routes for transit to a target destination;
calculate a route score for each candidate route based at least in part on predicted energy usage by the turbomachine and the electric machine along the respective route;
select a route for transit from the one or more candidate routes based upon the calculated route score; and
based on the selected route, selectively control the turbomachine and/or the electric machine to provide power changes to the propulsor during transit along the selected route without requiring pilot intervention.

2. The autoland control system of claim 1, wherein the autoland controller is configured to select one or more waypoints on the selected route based at least in part on characteristics of terrain along the route.

3. The autoland control system of claim 1, wherein the calculating the route score includes analyzing each route based on at least one of reducing waste energy, minimizing fuel consumption, or conserving electrical power.

4. The autoland control system of claim 1, wherein each of the one or more routes includes one or more of a navigation profile or an altitude profile.

5. The autoland control system of claim 4, wherein the autoland controller is configured to analyze an energy usage for the navigation profile or the altitude profile.

6. The autoland control system of claim 1, wherein the autoland controller is configured to select a route based at least in part on estimated passenger comfort, the estimated passenger comfort being based on predicted flight profile parameters including one or more of descent rate, number of turns, or expected in-flight noise levels.

7. The autoland control system of claim 6, wherein the autoland controller is configured to minimize aircraft noise oscillations and to suppress descent rates that exceed passenger comfort thresholds.

8. The autoland control system of claim 1, wherein the autoland controller is configured to analyze weather conditions to select the route.

9. The autoland control system of claim 1, wherein the autoland controller is configured to autonomously identify the target destination or receive the target destination from a pilot, and wherein the autoland controller is further configured to perform route selection and propulsion control without requiring pilot input.

10. The autoland control system of claim 1, wherein the autoland controller is configured to prioritize power to the turbomachine based upon a failure of the electric machine or conserve electrical power for the electric machine based upon a failure of the turbomachine.

11. An autoland control system for an aircraft, comprising:
a propulsor including one or more blades;
a turbomachine;
an electric machine; and
an autoland controller operatively coupled with the propulsor, the turbomachine, and the electric machine, the autoland controller configured to autonomously:
selectively control the turbomachine and/or the electric machine to provide power changes to the propulsor during a landing sequence on a runway;
detect a condition to abort or continue the landing sequence;
upon detection of a condition to abort landing on the runway, control the turbomachine and/or the electric machine to provide power to the propulsor to execute a go-around or missed approach; and
upon detection of a condition to continue landing on the runway, control the turbomachine and/or the electric machine to provide power to the propulsor to complete landing on the runway without requiring pilot intervention.

12. The autoland control system of claim 11, wherein the autoland controller is configured to detect a fouled runway.

13. The autoland control system of claim 12, wherein the autoland control system receives information about the fouled runway from one or more of an air to ground radar, forward looking infrared (FLIR) detection system, electronic communication from a control tower, or other air traffic control indication system.

14. The autoland control system of claim 11, wherein the autoland controller is configured to initiate go-around or missed approach procedures.

15. The autoland control system of claim 11, wherein the autoland controller is configured to idle the turbomachine.

16. The autoland control system of claim 11, wherein the autoland controller deploys landing gear.

17. An autoland control system for an aircraft, comprising:
a propulsor including one or more blades;
a turbomachine;
an electric machine; and
an autoland controller operatively coupled with the propulsor, the turbomachine, and the electric machine, the autoland controller configured to autonomously:
determine that an aircraft has landed on a runway;
control the turbomachine to transition to a forward idle state following landing;
determine, based upon an aircraft speed exceeding a first threshold, to initiate reverse thrust using the turbomachine; and
cause the turbomachine to transition to a non-operational state based upon the aircraft speed being below a second threshold and a parking brake being applied.

18. The autoland control system of claim 17, wherein the autoland controller is configured to, based upon the aircraft speed being below the first threshold, discontinue thrust reversing.

19. The autoland control system of claim 17, wherein the autoland controller is configured to maintain the idle state of the turbomachine.

20. The autoland control system of claim 17, wherein the autoland controller is configured to turn the turbomachine off.
